(19) United States
(12) Patent Application Publication
(10) Pub. No.: US 2024/0187614 A1
(43) Pub. Date: Jun. 6, 2024

(54) METHOD AND DEVICE WITH VIDEO CONVERSION

(71) Applicant: SAMSUNG ELECTRONICS CO., LTD., Suwon-si (KR)

(72) Inventors: Hyoa KANG, Suwon-si (KR); Hee Min CHOI, Suwon-si (KR)

(73) Assignee: SAMSUNG ELECTRONICS CO., LTD., Suwon-si (KR)

(21) Appl. No.: 18/350,233

(22) Filed: Jul. 11, 2023

(30) Foreign Application Priority Data
Dec. 1, 2022 (KR) 10-2022-0165805

(51) Int. Cl. H04N 19/184; G06V 10/764; G06V 10/82

(52) U.S. Cl. CPC H04N 19/184; G06V 10/764; G06V 10/82

(57) ABSTRACT

A processor-implemented method includes: initializing a neural network model with arbitrary values using a random seed; training the neural network model based on the arbitrary values; determining a number of coats and respective densities of the coats; learning respective scores of parameters of the neural network model based on the number of coats and the respective densities of the coats; determining mask information for determining the parameters of the neural network model to be comprised in each of the coats based on the scores; and generating a bitstream based on the number of coats, the respective densities of the coats, the mask information, and the random seed.

### CROSS-REFERENCE TO RELATED APPLICATIONS

This application claims the benefit under 35 USC § 119(a) of Korean Patent Application No. 10-2022-0165805, filed on Dec. 1, 2022 in the Korean Intellectual Property Office, the entire disclosure of which is incorporated herein by reference for all purposes.

BACKGROUND

### 1. Field

The following description relates to a method and a device with video conversion.

### 2. Description of Related Art

End-to-end video conversion technology may use an artificial neural network model. Video masks may be learned or trained to respond to various bitrates using an artificial neural network model and reduce a transmission amount. A model may be efficiently pruned using an artificial neural network model, and an amount of computation may be adjusted according to an environment when an artificial neural network model is used. An image may be encoded and transmitted using an implicit image compression method using an artificial neural network model, and a decoder may decode and output an image.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes: initializing a neural network model with arbitrary values using a random seed; training the neural network model based on the arbitrary values; determining a number of coats and respective densities of the coats; learning respective scores of parameters of the neural network model based on the number of coats and the respective densities of the coats; determining mask information for determining the parameters of the neural network model to be comprised in each of the coats based on the scores; and generating a bitstream based on the number of coats, the respective densities of the coats, the mask information, and the random seed.

The method may include determining scale information corresponding to each of the coats based on the number of coats and the respective densities of the coats, wherein the mask information is determined based on the determined scale information.

The determining of the scale information may include determining the scale information to be proportional to reciprocals of the respective densities of the coats.

The determining of the number of coats may include determining the number of coats based on a transmission bitrate constraint.

The determining of the respective densities of the coats may include classifying the densities of the coats in descending order based on the scores.

The training of the neural network model may include training the neural network model such that an output of the artificial neural network model is in a form of an output of a classifier network.

The training of the neural network model may include training the neural network model to output frame information of a frame corresponding to a predetermined point in time, and the frame information may include probability information of a probability that each of a plurality of pixels comprised in the frame belongs to a class corresponding to a pixel value.

The initializing of the neural network model may include initializing the parameters of the neural network model to a predetermined value or distribution.

The method may include transmitting the bitstream to a decoder.

The coats may include binary masks of weights of the neural network model.

In one or more general aspects, a non-transitory computer-readable storage medium stores instructions that, when executed by a processor, configure the processor to perform any one, any combination, or all of operations and/or methods described herein.

In one or more general aspects, a processor-implemented method includes: receiving a bitstream; obtaining a random seed, a number of coats, respective densities of the coats, and mask information by decoding the received bitstream; initializing a neural network model using the random seed; determining a number of coats and respective densities of coats to be used in the neural network model based on constraints on an amount of computation; based on the determined number of coats and the determined respective densities of the coats, determining scale information corresponding to the determined coats; and generating parameters of the neural network model based on the scale information and the mask information.

The method may include outputting frame information of a frame corresponding to a predetermined point in time based on the generated parameters.

In one or more general aspects, an electronic device includes: one or more processors configured to: initialize a neural network model with arbitrary values using a random seed; train the neural network model based on the arbitrary values; determine a number of coats and respective densities of the coats; learn respective scores of parameters of the neural network model based on the number of coats and the respective densities of the coats and determine mask information for determining the parameters of the neural network model to be comprised in each of the coats based on the scores; and generate a bitstream based on the number of coats, the respective densities of the coats, the mask information, and the random seed.

The one or more processors may be configured to determine scale information corresponding to each of the coats based on the number of coats and the respective densities of the coats, and the mask information is determined based on the determined scale information.

For the determining of the scale information, the one or more processors may be configured to determine the scale information is to be proportional to reciprocals of the respective densities of the coats.

For the determining of the number of coats, the one or more processors may be configured to determine the number of coats based on a transmission bitrate constraint.

For the determining of the respective densities of the coats, the one or more processors may be configured to classify the densities of the coats in descending order based on the scores.

For the training of the neural network model, the one or more processors may be configured to train the neural network model such that an output of the neural network model is in a form of an output of a classifier network.

For the training of the neural network model, the one or more processors may be configured to train the neural network model to output frame information of a frame corresponding to a predetermined point in time, and the frame information may include probability information of a probability that each of a plurality of pixels comprised in the frame belongs to a class corresponding to a pixel value.

For the initializing of the neural network model, the one or more processors may be configured to initialize the parameters of the neural network model to a predetermined value or distribution.

Other features and aspects will be apparent from the following detailed description, the drawings, and the claims.

### BRIEF DESCRIPTION OF THE DRAWINGS

FIG. 1A illustrates an example of a video encoder.

FIG. 1B illustrates an example of a video encoding method.

FIG. 2 illustrates an example of a mask learning method.

FIG. 3A illustrates an example of a video decoder.

FIG. 3B illustrates an example of a video decoding method.

FIG. 4 illustrates an example of a configuration of an electronic device.

Throughout the drawings and the detailed description, unless otherwise described or provided, it shall be understood that the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

The terminology used herein is for the purpose of describing particular examples only and is not to be limiting of the examples. The singular forms “a”, “an”, and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical or scientific terms, used herein have the same meaning as is commonly understood by one of ordinary skill in the art to which this disclosure pertains and based on an understanding of the disclosure of the present application. Terms, such as those defined in commonly used dictionaries, are to be construed to have meanings matching with contextual meanings in the relevant art and the disclosure of the present application, and are not to be construed to have an ideal or excessively formal meaning unless otherwise defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

Hereinafter, examples will be described in detail with reference to the accompanying drawings. In the descriptions of the examples referring to the accompanying drawings, like reference numerals refer to like elements and any repeated description related thereto will be omitted.

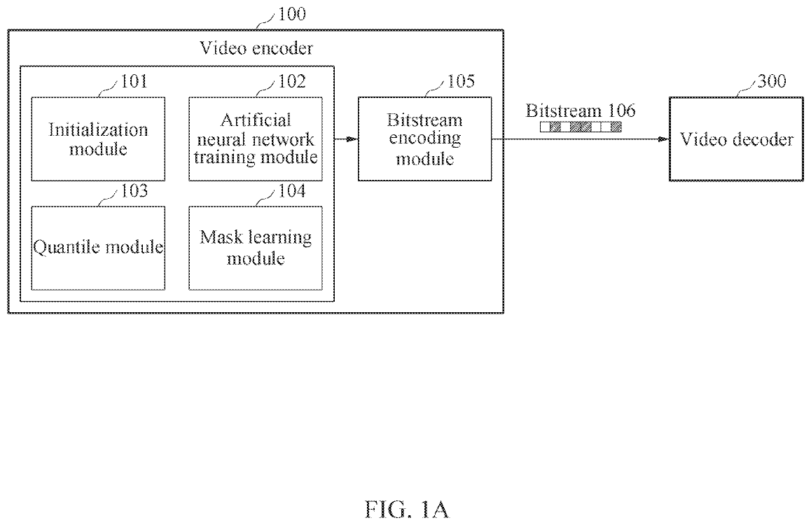

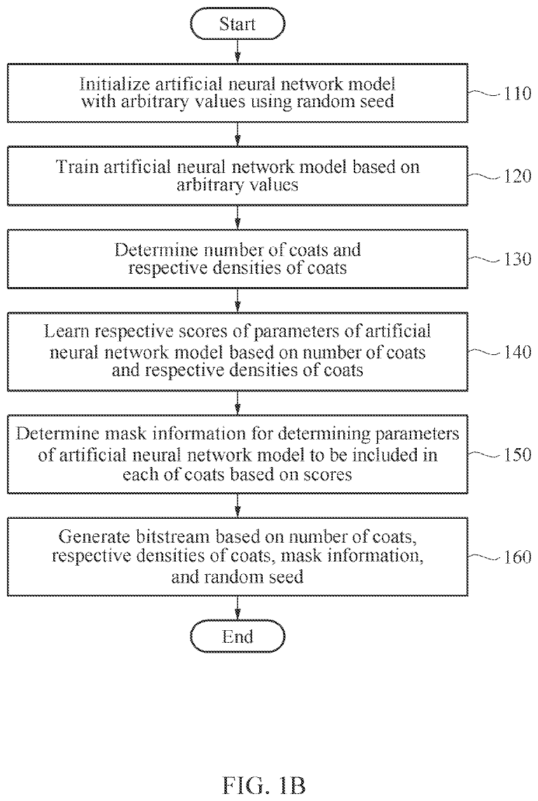

FIG. 1A illustrates an example of a video encoder.

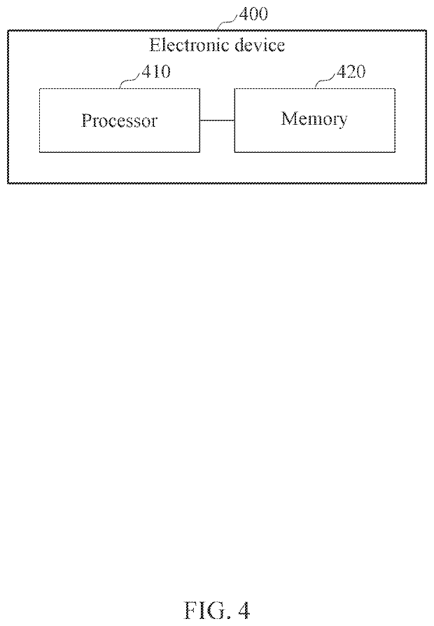

Referring to FIG. 1A, a video encoder 100 may be implemented through a processor (e.g., a processor 410 of FIG. 4) of an electronic device (e.g., an electronic device 400 of FIG. 4). The processor may control one or more operations of the electronic device. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the disclosure pertains that the processor may be implemented in other types of hardware.

The video encoder 100 may include an initialization module 101, an artificial neural network training module 102, a quantile module 103, a mask learning module 104, and a bitstream encoding module 105. The term “module” may be a component including o hardware (e.g., hardware implementing software). The “module” may interchangeably be used with other terms, for example, “logic,” “logical block,” “component,” or “circuit.” The “module” may be a minimum component of an integrally formed component or part thereof. The “module” may be a minimum component for performing one or more functions or part thereof. The “module” may be implemented mechanically or electronically. For example, the “module” may include any one or any combination of an application-specific integrated circuit (ASIC) chip, field-programmable gate arrays (FPGAs), and a programmable-logic device that performs known operations or operations to be developed.

The video encoder 100 may support a multi-bitrate through artificial neural network model (e.g., a neural network) training. The artificial neural network model may be configured in a form based on an implicit neural representation.

In a video codec based on the implicit neural representation, a spatial and temporal index or temporal index of an image may be used as an input, and an output of a randomly initialized artificial neural network model may be a video frame or a red, green, blue (RGB) pixel value of a video frame. The video encoder may transmit information about the artificial neural network model to a video decoder as a bitstream, and the video decoder may decode a video by inferring the artificial neural network model based on received parameters.

Operations of the video encoder 100 illustrated in FIG. 1A are described in detail later with reference to FIG. 1B, as an example.

FIG. 1B illustrates an example of a video encoding method.

Operations 110 to 160 of FIG. 1B may be performed in the shown order and manner. However, the order of one or more of the operations may change, one or more of the operations may be omitted, and/or one or more of the operations may be performed in parallel or simultaneously without departing from the spirit and scope of the shown example.

For ease of description, it is described that operations 110 to 160 are performed using the video encoder 100 illustrated in FIG. 1A. However, operations 110 to 160 may be performed by another component of an electronic device.

The description provided with reference to FIG. 1A may apply to the description provided with reference to FIG. 1B, and any repeated description related thereto is omitted.

In operation 110, the video encoder 100 may initialize the artificial neural network model with arbitrary values using a random seed. The initialization module 101 may initialize parameters of the artificial neural network model to a predetermined value or distribution.

The initialization module 101 may randomly initialize the artificial neural network model using the random seed. The initialization module 101 may transmit the parameters (e.g., one or more weights and/or one or more biases) of the randomly initialized artificial neural network model to an artificial neural network training module 102.

In operation 120, the video encoder 100 may train the artificial neural network model based on an arbitrary value.

The artificial neural network training module 102 may be configured such that an output of the artificial neural network model is an output of a classifier. The artificial neural network training module 102 may train the artificial neural network model based on the parameters of the artificial neural network model received from the initialization module 101 and mask information received from the mask learning module 104.

The artificial neural network training module 102 may train the artificial neural network model to output frame information of a frame corresponding to a predetermined point in time. The frame information may include probability information of a probability that each of a plurality of pixels included in the frame belongs to a class corresponding to a pixel value.

The output of the artificial neural network model trained in the artificial neural network training module 102 may be expressed by an intensity value for a pixel of the video frame. For example, a pixel value of the artificial neural network output may have an integer value between 0 and 255. When the output of the artificial neural network model is the output of the classifier, the artificial neural network model may output a probability that a received pixel belongs to a class of the classifier. Since the class of the classifier is not independent but has a correlation, the artificial neural network model may be effectively trained through label smoothing, and the like. The label smoothing may be a technique for improving normalization performance and may be used to smooth a label without changing an image for training. Accordingly, for example, not only may a probability be assigned to a class to which a predetermined pixel value belongs, but also a predetermined degree of probability may be assigned to other classes.

In operation 130, the video encoder 100 may determine a number of coats and respective densities of the coats. A coat may be a subset of total parameters of the artificial neural network model, and a density of a coat may be a ratio of selected parameters to the total parameters. For example, when a density of a coat is 10%, the coat may include parameters corresponding to 10% of the total parameters. A coat may be supermask, and a supermask may be a binary mask of weights of the artificial neural network model.

The quantile module 103 may determine the number of coats based on a transmission bitrate constraint. The quantile module 103 may classify densities of the coats in descending order based on scores of the parameters of the artificial neural network model.

The quantile module 103 may determine the number of coats according to the bitrate constraint and determine the densities of the plurality of coats. The quantile module 103 may classify the parameters of the artificial neural network model into the plurality of coats. The plurality of coats may be classified in descending order according to a density kₙ.

For example, when the number of coats is N, an order of the densities of the coats may be k₁>k₂> . . . >Kₙ, and parameters to be included in each coat may be determined based on a score of each of the parameters.

In operation 140, the video encoder 100 may learn the score of each of the parameters of the artificial neural network model based on the number of coats and the respective densities of the coats.

The quantile module 103 may determine the parameters to be included in each coat through a Top-kₙ % operation based on the score of each of the parameters. A Top-kₙ % operation may be an operation of classifying scores in descending order and sorting parameters by quantile according to the scores. According to the Top-kₙ % operation, the parameters may be sorted based on the scores, and the parameters to be included in each coat may be determined. For example, when 100 parameters have scores between 0 and 1, a coat density (k₁) of a first coat is 10%, and a score corresponding to the top 10% of the scores is 0.9, parameters with scores higher than 0.9 may be classified into the first coat.

The video encoder 100 may determine scale information corresponding to each coat based on the number of coats and the respective densities of the coats.

The quantile module 103 may determine the scale information to be proportional to reciprocals of the respective densities of the coats. Referring to Equation 1 below, for example, a scale value may be determined based on a reciprocal of a density of a coat. For example, according to Equation 1 below, as the density of the coat decreases the scale value increases, and an appropriate offset may be subtracted such that a scale value of the first coat is 1.

$${scale}_{i} = \frac{{k}_{N}}{{k}_{i}} + 1 - \frac{{k}_{N}}{{k}_{1}} \qquad Equation 1$$

N may denote the number of coats, kᵢ may denote a density of an i-th coat, K_{N} may denote a density of an N-th coat, and scale; may denote a scale value to be applied to the i-th coat.

In operation 150, the video encoder 100 may determine mask information for determining the parameters of the artificial neural network model to be included in each of the coats based on the scores. For example, the mask information may be a value for determining whether to select a parameter. For example, when a mask corresponding to a parameter is a first value (e.g., 1), the parameter may be selected to be included in a coat, and when a mask corresponding to a parameter is a second value (e.g., 0), the parameter may be selected not to be included in (e.g., excluded from) the coat. The video encoder 100 of one or more embodiments may improve video conversion technology by reducing a transmission amount by transmitting mask information having values of 0 and 1 instead of transmitting the total parameters of the artificial neural network model.

The mask learning module 104 may determine the mask information based on the number of coats, the respective densities of the coats, the scores, and the scale information. The mask information may be information to be included in each of the coats to determine the parameters of the artificial neural network model in a video decoder 300.

In operation 160, the video encoder 100 may generate a bitstream based on the number of coats, the respective densities of the coats, the mask information, and the random seed.

The bitstream encoding module 105 may generate and transmit the bitstream using entropy coding by gathering the mask information obtained by classifying the parameters into the plurality of coats based on trained scores, a scale value of each of the coats, and random seed information used to initialize the artificial neural network model.

In a typical video codec based on an implicit neural representation, when a number of parameters having a B-bit length is M and parameters corresponding to (1-k) % are pruned and transmitted, a number of bits to be transmitted may be expressed as shown in Equation 2 below, for example. In order to support a different bitrate, the typical video codec may need to perform pruning and artificial neural network model training again.

$$M \times \frac{{k}_{1}}{100} \times B \qquad Equation 2$$

In contrast, the bitstream generated using the above-mentioned video encoder 100 of one or more embodiments may include a binary mask value that determines whether a parameter belongs to each coat, N B-bit intensity values, each of which corresponds to each coat, and a B-bit random seed. For example, the video encoder 100 may transmit a bitstream having the number of bits as represented by Equation 3 below, for example.

$$( 1 + {\sum }_{n = 2}^{N} \frac{{k}_{n}}{100} ) M + N \times B + B \qquad Equation 3$$

Comparing Equation 2 and Equation 3, Equation 3 may have the number of bits less than N/B compared to Equation 2.

Accuracy of the artificial neural network model and a transmission bitrate of the video encoder 100 may increase as the number of coats increases. Thus, the video encoder 100 of one or more embodiments may improve video conversion technology by learning scores by determining the number of coats and a density according to the transmission bitrate constraint and by supporting a multi-bitrate by including only masks of Top-n coats in the bitstream when the scores are already learned without additional artificial neural network model training.

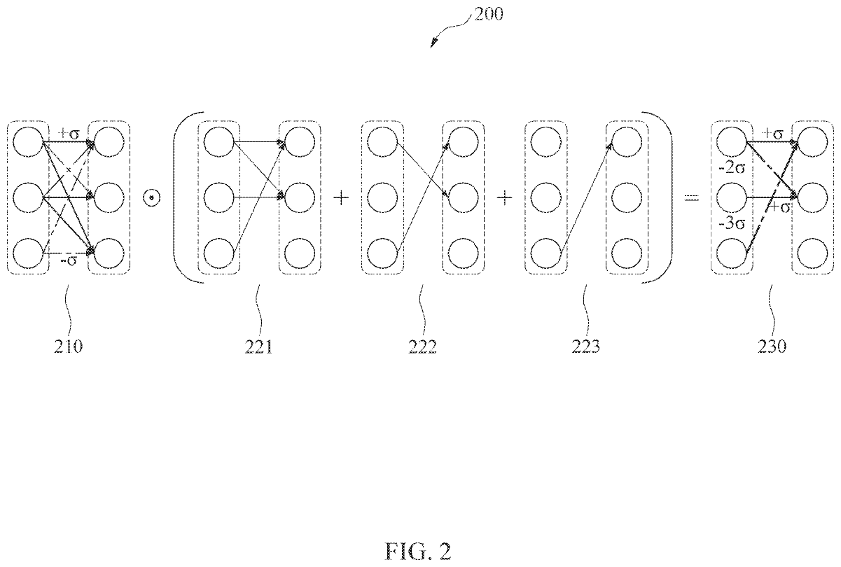

FIG. 2 illustrates an example of a mask learning method.

The description provided with reference to FIGS. 1A and 1B may apply to FIG. 2, and thus, any repeated description related thereto may be omitted.

FIG. 2 illustrates that a mask learning method 200 may be performed using the video encoder 100 illustrated in FIG. 1A. However, the mask learning method may be used through any other proper electronic device or process or in any proper system.

The mask learning method 200 may be performed by the mask learning module 104. The mask learning method 200 may be a method of learning parameters of an artificial neural network model through a mask obtained by adding supermasks (e.g., coats including a first supermask 221, a second supermask 222, and a third supermask 223) to random weights 210.

For example, the random weights 210 may be obtained by randomly initializing weight values using a random seed and extracting mask information of the weights. The first supermask 221 may select four weights (e.g., respectively corresponding to four connections) to use from among randomly initialized weights. The second supermask 222 may select two weights to use from among the randomly initialized weights. The third supermask 223 may select one weight to use from among the randomly initialized weights. Mask information 230 including parameters of a trained artificial neural network may be generated by multiplying the random weights 210 by the supermasks 221 to 223 in which the weights to be used are selected. The mask information 230 may learn scores in which greater weights are assigned to repeatedly used weight values and scores in which less weights are assigned to less used weight values in the supermasks 221 to 223. In the mask learning method 200 of the present disclosure, a number of weights and a number of supermasks are not limited to the described examples.

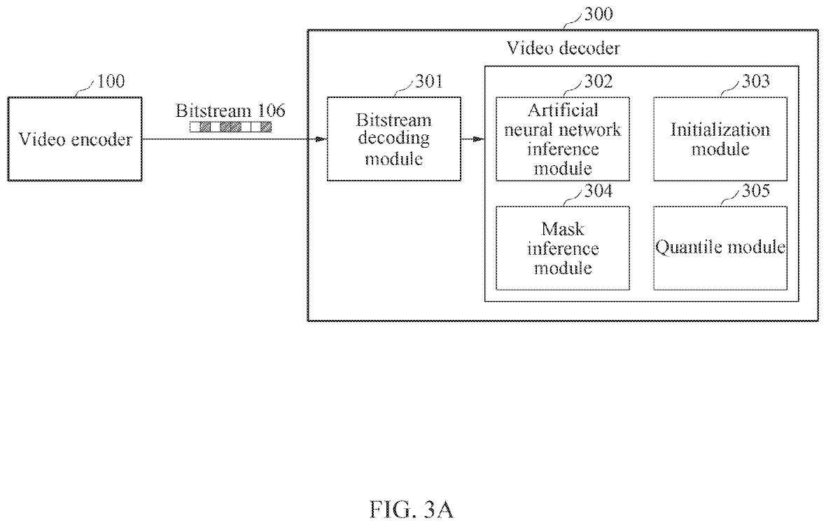

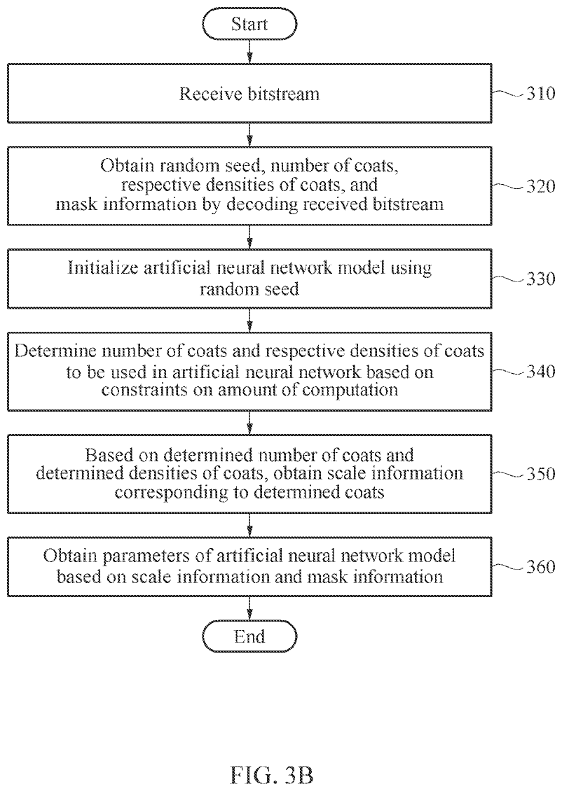

FIG. 3A illustrates an example of a video decoder.

As illustrated in FIG. 3A, the components may be implemented by a special-purpose hardware-based computer that performs a predetermined function (e.g., special-purpose hardware implementing computer instructions).

The video encoder 300 may be implemented through a processor (e.g., the processor 410 of FIG. 4) of an electronic device. The processor may control one or more operations of the electronic device (e.g., the electronic device 400 of FIG. 4). The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the disclosure pertains that the processor may be implemented in other types of hardware.

The video decoder 300 may include a bitstream decoding module 301, an artificial neural network inference module 302, an initialization module 303, a mask inference module 304, and a quantile module 305.

Operations of the video decoder illustrated in FIG. 3A are described in detail later with reference to FIG. 3B, for example.

FIG. 3B illustrates an example of a video decoding method.

Operations 310 to 360 of FIG. 3B may be performed in the shown order and manner. However, the order of one or more of the operations may change, one or more of the operations may be omitted, and/or one or more of the operations may be performed in parallel or simultaneously without departing from the spirit and scope of the shown example.

The description provided with reference to FIG. 3A may apply to FIG. 3B, and any repeated description related thereto may be omitted.

For ease of description, it is described that operations 310 to 360 are performed using the video encoder 300 illustrated in FIG. 3A. However, operations 310 to 360 may be performed by another component of an electronic device.

In operation 310, the video decoder 300 may receive a bitstream from the video encoder 100. The video decoder 300 may input the received bitstream to a bitstream decoding module 301.

In operation 320, the video decoder 300 may obtain a random seed, a number of coats, respective densities of the coats, and mask information by decoding the received bitstream.

The bitstream decoding module 301 may obtain a random seed used in the video encoder 100, a number of coats determined in the video encoder 100, respective densities of the coats, and mask information learned in the video encoder 100 by decoding the received bitstream.

In operation 330, the video decoder 300 may initialize an artificial neural network model using the random seed.

The initialization module 303 may initialize parameters of the artificial neural network model to a predetermined value or distribution using the random seed obtained by decoding the bitstream.

In operation 340, the video decoder 300 may determine the number of coats and respective densities of the coats to be used in the artificial neural network based on constraints on an amount of computation.

The quantile module 305 may determine the number of coats and the respective densities of the coats corresponding to an amount of computation of the video decoder 300 based on performance of the video decoder 300 and the mask information included in the received bitstream. The quantile module 305 may control an amount of computation used to scale parameters according to the determined number of coats.

In operation 350, the video decoder 300 may obtain, based on the determined number of coats and the determined densities of the coats, scale information corresponding to the determined coats.

The quantile module 305 may obtain the scale information corresponding to the determined coats from the received mask information based on the determined number of coats and the determined densities of the coats.

The mask inference module 304 may infer mask information corresponding to the constraints on the amount of computation of the video decoder 300 based on the determined number of coats, the determined densities of the coats, and the obtained scale information.

In operation 360, the video decoder 300 may obtain the parameters of the artificial neural network model based on the scale information and the mask information.

The artificial neural network inference module 302 may infer the parameters of the artificial neural network model trained in the video encoder 100. The artificial neural network inference module 302 may obtain the parameters of the artificial neural network model to be used in the video decoder 300 based on the determined number of coats, the determined densities of the coats, the obtained mask information, and the inferred mask information.

The video decoder 300 may output frame information of a frame corresponding to a predetermined point in time based on the obtained parameters. For example, when receiving an input requesting that the video decoder 300 outputs a video frame at the predetermined point in time, the video decoder 300 may output pixel values at the predetermined point in time and output them as video frame information of the predetermined point in time.

FIG. 4 illustrates an example of a configuration of an electronic device. Referring to FIG. 4, an electronic device 400 may include a processor 410 (e.g., one or more processors) and a memory 420 (e.g., one or more memories). The memory 420 may be connected to the processor 410 and may store instructions executable by the processor 410, data to be operated by the processor 410, or data processed by the processor 410. The memory 420 may include a non-transitory computer readable medium, for example, a high-speed random-access memory (RAM), and/or a non-volatile computer readable storage medium (e.g., one or more disk storage devices, flash memory devices, or other non-volatile solid state memory devices). For example, the memory 420 may include a non-transitory computer-readable storage medium storing instructions that, when executed by the processor 410, configure the processor 410 to perform any one, any combination, or all of the operations and methods described herein with reference to FIGS. 1-4. The electronic device 400 may be implemented as at least one of a mobile device, such as a mobile phone, a smart phone, a personal digital assistant (PDA), a netbook, a tablet computer, and/or a laptop computer, a wearable device, such as a smart watch, a smart band, and/or smart glasses, a home appliance, such as a television (TV), a smart TV, and/or a refrigerator, a security device, such as a door lock, and/or a vehicle, such as an autonomous vehicle, and/or a smart vehicle.

The processor 410 may execute the instructions to perform the operations described with reference to FIGS. 1 to 3B. The processor 410 may include the video encoder 100 and video decoder 300 described above with reference to FIGS. 1A and 3A.

In addition, the descriptions provided with reference to FIGS. 1 to 3B may apply to the electronic device 400.

The video encoders, initialization modules, artificial neural network training modules, quantile modules, mask learning modules, bitstream encoding modules, video decoders, bitstream decoding modules, artificial neural network inference modules, mask inference modules, electronic devices, processors, memories, video encoder 100, initialization module 101, artificial neural network training module 102, quantile module 103, mask learning module 104, bitstream encoding module 105, video decoder 300, bitstream decoding module 301, artificial neural network inference module 302, initialization module 303, mask inference module 304, quantile module 305, electronic device 400, processor 410, memory 420, and other apparatuses, devices, units, modules, and components disclosed and described herein with respect to FIGS. 1-4 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-4 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
initializing a neural network model with arbitrary values using a random seed;
training the neural network model based on the arbitrary values;
determining a number of coats and respective densities of the coats;
learning respective scores of parameters of the neural network model based on the number of coats and the respective densities of the coats;
determining mask information for determining the parameters of the neural network model to be comprised in each of the coats based on the scores; and
generating a bitstream based on the number of coats, the respective densities of the coats, the mask information, and the random seed.

2. The method of claim 1, further comprising determining scale information corresponding to each of the coats based on the number of coats and the respective densities of the coats, wherein the mask information is determined based on the determined scale information.

3. The method of claim 2, wherein the determining of the scale information comprises determining the scale information to be proportional to reciprocals of the respective densities of the coats.

4. The method of claim 1, wherein the determining of the number of coats comprises determining the number of coats based on a transmission bitrate constraint.

5. The method of claim 1, wherein the determining of the respective densities of the coats comprises classifying the densities of the coats in descending order based on the scores.

6. The method of claim 1, wherein the training of the neural network model comprises training the neural network model such that an output of the artificial neural network model is in a form of an output of a classifier network.

7. The method of claim 1, wherein
the training of the neural network model comprises training the neural network model to output frame information of a frame corresponding to a predetermined point in time, and
the frame information comprises probability information of a probability that each of a plurality of pixels comprised in the frame belongs to a class corresponding to a pixel value.

8. The method of claim 1, wherein the initializing of the neural network model comprises initializing the parameters of the neural network model to a predetermined value or distribution.

9. The method of claim 1, further comprising transmitting the bitstream to a decoder.

10. The method of claim 1, wherein the coats comprise binary masks of weights of the neural network model.

11. A processor-implemented method comprising:
receiving a bitstream;
obtaining a random seed, a number of coats, respective densities of the coats, and mask information by decoding the received bitstream;
initializing a neural network model using the random seed;
determining a number of coats and respective densities of coats to be used in the neural network model based on constraints on an amount of computation;
based on the determined number of coats and the determined respective densities of the coats, determining scale information corresponding to the determined coats; and
generating parameters of the neural network model based on the scale information and the mask information.

12. The method of claim 11, further comprising outputting frame information of a frame corresponding to a predetermined point in time based on the generated parameters.

13. An electronic device comprising:
one or more processors configured to:
initialize a neural network model with arbitrary values using a random seed;
train the neural network model based on the arbitrary values;
determine a number of coats and respective densities of the coats;
learn respective scores of parameters of the neural network model based on the number of coats and the respective densities of the coats and determine mask information for determining the parameters of the neural network model to be comprised in each of the coats based on the scores; and
generate a bitstream based on the number of coats, the respective densities of the coats, the mask information, and the random seed.

14. The electronic device of claim 13, wherein the one or more processors are configured to determine scale information corresponding to each of the coats based on the number of coats and the respective densities of the coats, and the mask information is determined based on the determined scale information.

15. The electronic device of claim 14, wherein, for the determining of the scale information, the one or more processors are configured to determine the scale information is to be proportional to reciprocals of the respective densities of the coats.

16. The electronic device of claim 13, wherein, for the determining of the number of coats, the one or more processors are configured to determine the number of coats based on a transmission bitrate constraint.

17. The electronic device of claim 13, wherein, for the determining of the respective densities of the coats, the one or more processors are configured to classify the densities of the coats in descending order based on the scores.

18. The electronic device of claim 13, wherein, for the training of the neural network model, the one or more processors are configured to train the neural network model such that an output of the neural network model is in a form of an output of a classifier network.

19. The electronic device of claim 13, wherein
for the training of the neural network model, the one or more processors are configured to train the neural network model to output frame information of a frame corresponding to a predetermined point in time, and
the frame information comprises probability information of a probability that each of a plurality of pixels comprised in the frame belongs to a class corresponding to a pixel value.

20. The electronic device of claim 13, wherein, for the initializing of the neural network model, the one or more processors are configured to initialize the parameters of the neural network model to a predetermined value or distribution.
